(19) United States
(12) Patent Application Publication
(10) Pub. No.: US 2013/0074384 A1
(43) Pub. Date: Mar. 28, 2013

(54) METHOD FOR ILLUMINATING A LIGHT BOX

(71) Applicants: Karl-Heinz Fenkart, Hohenems (AT); Frank Horn, Engi (CH)

(72) Inventors: Karl-Heinz Fenkart, Hohenems (AT); Frank Horn, Engi (CH)

(73) Assignees: TRIDONIC AG, Ennenda (CH); TRIDONIC GMBH & CO. KG, Dornbirn (AT)

(21) Appl. No.: 13/637,395

(22) PCT Filed: Mar. 30, 2011
(86) PCT No.: PCT/AT11/00156

§ 371 Date: Dec. 5, 2012

(30) Foreign Application Priority Data
Mar. 31, 2010 (AT) GM213/2010

(51) Int. Cl. G09F 13/00

(52) U.S. Cl. CPC G09F 13/005
USPC 40/541

(57) ABSTRACT

A light box (10), for illuminated advertising, has at least one transparent front face (FS), which is illuminated by at least two lamps, includes at least two lighting devices (La1, La2), at least two operating devices (BG1, BG2) for operating each lighting device (La1, La2), wherein the operating devices (BG1, BG2) each have a first interface (IN11, IN12) and the first interfaces (IN11, IN12) are connected to each other and to a control device (SG). Two different sensors (SE1, SE2) are connected to the control device (SG) and the lighting devices (La1, La2) are actuated by the operating devices (BG1, BG2) according to the control signals received via the first interface (IN11, IN12).

The invention relates to a method for illuminating a light box having at least two lighting means and operating devices for this purpose according to the preamble of claim 1. Moreover, the present invention relates to an illumination system for illuminating a light box according to the preamble of claim 2.

### TECHNICAL FIELD AND PRIOR ART

Light boxes are presently used in particular for illumination of advertising signs. At the same time, traditional incandescent lamps were recently mostly replaced by gas discharge lamps.

### SUMMARY OF THE INVENTION

The object of the invention is to improve the method for illuminating a light box which is provided with illuminating means devices. The invention takes into account in particular the requirements for energy efficiency and the need to protect the illuminating means.

This objective of the invention is achieved with the features of the independent claims. The dependent claims relate to a further development of the central concept in a particularly advantageous manner.

According to the invention, a method for illuminating a light box is proposed, preferably for illuminated advertising, wherein
two illuminating means are operated, respectively, by an operating device,
the operating devices are connected to each other through an interface,
one control device is connected with both operating devices through the interface,
at least two different sensors are connected with the control device,
wherein the control device transmits control signals through the first interface which are dependent on the signal detected by means of the function of the sensors, and the illuminating means are controlled depending on the control signals which are received through the first interface.

The invention also relates to a light box, preferably for illuminated advertising, having at least a transparent front panel which is illuminated by at least two illuminating means, comprising
at least two illuminating means,
at least two operating devices for operating each of the illuminating means, wherein the operating devices are provided with a first interface and the interfaces are connected with each other and with a control device so that two different sensors are connected with a control device and the illuminating means is controlled by control signals which are received through the first interface depending on the control devices.

According to the invention, a method is proposed for controlling electronically controlled devices for illumination means. Typical examples of such an illuminating means device include electronic ballasts [EVG in German, EB in English] for gas discharge lamps or operating devices for organic or inorganic light emitting diodes.

According to the invention, a computer software product is disclosed which supports a method according to any of the claims mentioned above when it is run on a computing unit.

The invention also relates to a lighting system for controlling electronically controlled lighting means devices in light boxes, wherein the lighting system is provided with at least two lighting means devices and at least with two sensors. The respective sensors are connected with the control device, and devices operating the lighting means are also connected with the control device.

The objective of the invention for a generic device is achieved according to the invention by the characterizing features of patent claim 2 and for a generic method according to the invention with claim 1. Particularly advantageous embodiments of the invention are described in the dependent claims.

### DESCRIPTION OF PREFERRED EMBODIMENT OF THE INVENTION

Further advantages, features and characteristics of the present invention will now be explained with respect to the attached two figures.

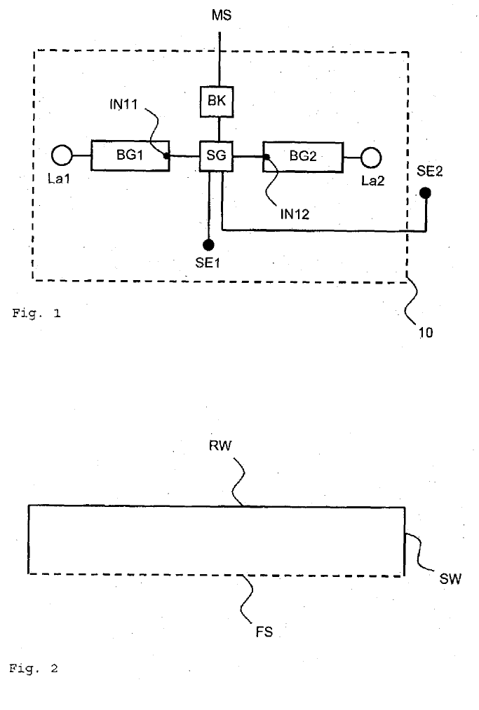

FIG. 1 shows an arrangement of an illuminating system according to the invention for a light box.

FIG. 2 shows a profile of a light box.

FIG. 1 shows a schematic representation of a light box (10) with included lighting. The light box (10) is provided with an illumination system which is used to control at least two illuminating means (La1, La2). At the same time, at least two operating devices (BG1, BG2) are provided to operate each of the illuminating means.

Each operating device (BG1, BG2) is provided with a first interface (IN11, IN12) and the first interfaces (IN11, IN12) are connected to each other. One control device (SG) is also connected to both operating devices (BG1, BG2) through the interfaces (IN121, IN12). At least two different sensors (SE1, SE2) are connected with the control device (SG). The control device (SG) transmits control signals through the first interface (IN11, IN12) which depend on the sensor signals detected by the sensor, and the illuminating means (LA1, LA2) are controlled by the control devices (BG1, BG2) depending on the control signals that are received through the first interface (IN11, IN12).

The control devices (BG1, BG2) can also optionally transmit control signals through the first interface (IN11, IN12). As mentioned above, the illuminating means can be controlled by the control devices (BG1, BG2) depending on the control signals which are received through the interface (IN11, IN12).

The illuminating means (La1, La2) may be in principle any illuminating means, such as for example gas discharge lamps or organic or inorganic light emitting diodes. The operating devices (B1, BG2) shown in the illustrations are provided with connections which can be connected to a protective conductor (ground), a phase conductor and to a neutral conductor in order to supply energy to the operating devices (BG1, BG2). The operating device (BG1, BG2) is provided as mentioned above with a first interface (IN11, IN12) having connections for connecting to a bus system (wherein this bus system is not necessarily formed as a digital two-wire bus system, but instead it can be formed for example as a system for transfer of information through a power line, or via wireless communication).

The first interface (IN11, IN12) may be designed in such a way that digital signals are transmitted through these connections according to the DALI standard protocol, or according to the DSI protocol of the Tridonic Company, or so that the operating device can optionally also send signals. Optionally or alternatively, the first interface (IN11, IN12) can be also designed so that signals can be transmitted through the power supply, such as for example through the line voltage, but also as probe signals.

Unidirectional or bidirectional communication can thus be enabled through the first interface (IN11, IN12) between the control device (SG) and the operating devices (BG1, BG2).

The first sensor (SE1) can be used to monitor the brightness within the light box, while the second sensor (SE2) can be used to monitor the brightness outside the light box.

A motion sensor can be additionally also connected to the control device (SG). For example, the system can react in order to respond to an approaching person or to the presence of a person, and the brightness in the light box can be increased when it is detected that a person is approaching or that a person is present.

The control device (SG) can optionally also perform an evaluation of the time of day based on the ambient brightness and adjust the control of the operating devices (BG1, BG2) to the detected time of the day.

The light box may be further also equipped with at least one interface (IN11, IN12).

The operating device (BG1, BG2) can be additionally also provided with another (second) interface (IN21, IN22), not shown in FIG. 1. To this additional (second) interface (IN21, IN22) can be connected an additional sensor (SEB1, SEB2), for example a brightness sensor or a motion sensor. The use or the manner in which this additional (second) interface (IN21, IN22) is used can be provided in a programmable manner.

The sensor signals supplied to the additional (second) interface (IN21, IN22) can be provided as signals of a motion sensor or as signals of a brightness sensor.

An operating device (BG1, BG2) may upon receiving a sensor signal transmitted through the first interface (IN11, IN12) evaluate the sensor signal from another (second) interface (IN21, 22). An operating device (BG1, BG2) can as explained above upon the reception of s signal received through the first interface (IN11, IN12) control the connected illuminating means (La1, La2) after the evaluation of the control signal.

The illuminating system can be also provided with further operating devices (BG3, BG3) having at least one first interface (IN13, IN14, not shown in FIG. 1). Other operating devices (BG3) can be also provided at the same time, which also have a second interface (IN23), so that yet another sensor (SEB3) can be optionally connected to these devices.

A bus coupler (BK) can be provided, which is connected to the first interface (IN11, IN12) and which enables coupling of the interface to a superordinate control system (MS).

However, the control device (SG) can also allow a direct interface coupling to a superordinate control system (MS).

Through the first interface (IN11, IN12) various control signals can be transmitted, so that only some of the transmitted control signals are further transmitted by the bus coupler (BK) or by the control device (SG) to the superordinate control system (MS). The bus coupler (BK) can be also integrated into the control device (SG). For example, DALI commands can be transmitted as control signals which are further transmitted by the bus coupler (BK) to the superordinate control system. These control signals can be also further transmitted by the bus coupler (BK) directly as DALI commands to the superordinate control system, but they can be also converted to another protocol and then transmitted to the superordinate control system (MS).

In addition, commands differing from standard DALI commands can be also transmitted as control signals (for example according to a different protocol or in an extended DALI protocol), wherein these control signals are not further transmitted by the bus coupler (BK) to the superordinate control system (MS). In this manner, a local control can be maintained within the illuminating system with the operating devices (BG1, BG2, BG3, BG4) in the light box, but also within a certain area, wherein this is performed based on supervision realized with various sensors (SE1, SE2, SE3), while additional external control information can be received by the superordinate control system (MS), such as for example turn-on and turn-off commands, as well as information about the status of the illuminating system (such as for instance error messages or warnings), which can be transmitted from the illuminating system to the superordinate control system (MS).

The lighting means can be organic or inorganic LEDs, or a gas discharge lamp (fluorescent lamp, high-pressure gas discharge lamp). However, these can also be various other lighting means, for example, one lighting means in the form of an organic or inorganic LEDs, while another lighting means can be a gas discharge lamp (fluorescent lamp, high-pressure gas discharge lamp).

Both lighting means are arranged inside the light box. The light can be preferably used for illuminated advertising, and monitoring inside the light box (10) can be performed by means of the first sensor (SE1), while monitoring outside the light box (10) can be performed by means of the second sensor (SE2).

Efficient advertising illumination can thus be realized by means of a light box 10 according to the invention.

FIG. 2 shows a view of a typical configuration of a light box (10) (a cross-section through the light box is indicated). This light box 10 can be provided with a transparent or a partially transparent front side (FS). The light box (10) is preferably provided with a reflective back side (RW), or alternatively with a partially transparent back side (RW). The light box (10) can be further provided with a reflecting side wall (SW) or a transparent side wall (SW). The side wall (10) can be also configured as a partially transparent side wall (10). A reflector means is thus obtained when the reflective side parts (side walls or back side) are employed for the light box (10).

Furthermore, the light box (10) is equipped as mentioned above at least with two lighting means (La1, La2), which are preferably oriented in such a way so that the light rays that are emitted by the lighting means (La1, La2) and deflected by the reflection means are beamed between the back side (RW) and the front side (FS) of the light box (1), or onto one of both of these sides. The front side (FS) can be formed for example by a diffuser plate. The side walls (SW) can be optionally also formed as partially transparent side parts, for example with a diffusor plate.

With the application of the method or the illuminating system according to this invention, the light box (10) can be controlled so that it is optimally adjusted depending on the external brightness (detected by the sensor SE2), and also depending on the actual brightness within the light box (10) (detected by the sensor SE1). This makes it possible to achieve illumination of a light box (10) which is very energy-efficient.

This example of a light box (10) according to the invention which is equipped with an illuminating system according to the invention will now be explained in more detail. The control device (SG) can determine by monitoring the second sensor (SE2) when the ambient brightness (which is to say the external brightness) is below a certain value. At this point, the control device (SG) can transmit a corresponding control signal according to the evaluation of the sensor signal of the second sensor (SE2) through the first interface (IN11, IN12) and adjust by means of the operating devices (BG1, BG2) the control, preferably the brightness, which is adjusted according to the connected illuminating means (La1, La2).

Furthermore, the control device (SG) can detect the actual value of the brightness within the light box by means of a first sensor (SE1) which is connected to the control device (SG). Depending on the evaluation of both sensors (SE1, SE2), the control device (SG) can transmit corresponding control signals through the first interface (IN11, IN12) and the control devices (BG1, BG2) can operate in a corresponding manner the connected lighting means (La1, La2), for example by adjusting their brightness.

The other operating devices (BG3, BG4), which are also connected to the first interface (IN13, IN14) through the bus system, can also receive this signal. All other operating devices (BG3, BG4) can thus receive this control signal through their first interface (IN13, IN14).

In a further development of the invention, the first operating device (BG1) can alternatively or in addition transmit a control signal also through the first interface (IN11) based on an evaluation of the received control signal and of the sensor signal which is detected by the second interface (IN211). This control signal can be then received by the second operating device (BG2) (through the first interface IN12) and it may be used to adjust the control of the illuminating means (La2) in reaction to the received control signal.

Depending on the parameters and the threshold values which are designed for the monitoring of the sensors (SE1, SE2), the lighting system can thus be controlled and optimally adjusted within the light box (10).

The function of the detected sensor signals can thus be designed in different directions and different modes of operations can be determined for the individual lighting means (La1, La2).

As was already mentioned, a motion detector can be also used for a second sensor (SE2) or other sensors (SE3), (for example a passive infrared sensor, also referred to as PIR), a brightness sensor, an infrared sensor (for example a receiver for remote control using infrared rays), or a color sensor can be used (for example for adjustment of the color temperature, of the color locus, or of the transmission wavelength), or a combined sensor can be used such as a brightness sensor which is combined with a motion sensor. When a motion sensor is used as a second sensor (SE2), it is for example conceivable that when movement is detected in the vicinity of the light box (1) (including outside of the light box), the lighting means (La1, La2) can be turned on, or its brightness can be changed accordingly.

The monitoring within the light box can be used for example to perform a compensation with respect to the brightness and/or the color temperature (or also the color locus of the transmission wavelength) resulting from aging of the lighting means, or based on pollution or contamination, so that the brightness fluctuations can be changed and thus compensated for based on changes of temperature (for example with a reduced efficiency of fluorescent lamps at low temperature, for instance in case of frost).

In the example which is shown in FIG. 1, the illuminating system can be designed for instance in such a way that that a brightness sensor (for example a daylight sensor or a photodiode) is used as the first sensor (SE1) which is connected to the control device (SG). The brightness sensor can be also arranged for example so that it detects ambient light, which is to say the light during day. A motion detector (for example a passive infrared ray sensor, also called PIR) can be also connected to the control device (SG) as a second sensor (SE2). A third sensor (SE3), for example an infrared rays sensor, can be optionally also connected (for instance as a receiver for remote control per infrared rays, also known as IR interface) to the control device (SG), not shown in the figure. This infrared ray sensor can be used for programming and addressing of the illuminating system as well as for the presetting of a desired brightness value.

However, it would be also possible to use for example the brightness sensor as the first sensor (SE1) which generates the sum from the artificial light through the illuminating means (La1, La2) in order to detect the ambient light so that the brightness of the illuminating system is adjusted accordingly. At the same time, the brightness sensor can also detect the sum from artificial light and from the ambient light so that the brightness of the artificial light is adjusted according to the preset values.

However, a control algorithm may be also provided so that the control device (SG) changes the brightness of the illuminating means (La1, La2) through a corresponding control signal and the subsequent changes of the brightness are detected by the brightness detector. Depending on whether a sufficient change has been implemented, the changed control of the lighting means (La1, La2) can be maintained, or a further change of the lighting means (La1, La2) can be initiated by transmitting new control signals. The proportion of artificial light and/or the proportion of ambient light can thus be determined in this manner. This can be done for example by changing the proportion of artificial light, wherein the change of the brightness detected during this change is evaluated and based on this change of the brightness, the use of the proportion of artificial light or of ambient light can be stopped. At the same time, the change of the brightness can be quickly carried out so that this change of the brightness is not perceptible by human eye.

As an alternative, however a very slight brightness change or a very slow brightness change can be carried out so that this change of the brightness is not perceptible by human eye, or at least so that it is not perceived as disturbing. However, it is also possible to disable artificial light at least for a short period of time (which is to say to turn it off) and to perform measurement with the brightness sensor during the phase when it is turned off.

After that, artificial light can be again turned on and ambient light can be closed based on the difference between the detected brightness and the ambient light. It is also possible to choose a shutoff phase which is preferably so short that the change in the brightness is not perceptible to human eye.

Alternatively, it also possible to use for example two separate brightness sensors, wherein one brightness sensors detects artificial light and another brightness sensor detects ambient light. It is also possible to connect further sensors such as brightness sensors to the control device (SG).

Since several operating devices (BG1, BG2, BG3) may be present, each provided with a first interface (IN11, IN12, IN13), it can be advantageous when several other individual sensors (SE1, SE2, SE3) are connected to the control device (SG) so that a very flexible and powerful lighting system can be created in a simple manner for a light box.

Therefore, a method for illuminating a light box is enabled, preferably for illuminated advertising, which is provided with at least two lighting means, wherein two lighting means (La1, La2) are respectively operated by one operating device (BG1, BG2), and all the operating devices (BG1, BG2) are mutually connected to a first interface (IN11, IN12).

A control device (SG) is connected with both operating devices (BG1, BG2) through the first interface (IN11, IN12), wherein at least two different sensors (SE1, SE2) are connected to the control device (SG). The control device (SG) sends control signals through the first interface (IN11, IN12), which depend on the sensor signals detected by the sensors, and the lighting means (La1, La2) are controlled depending on the control signals which are received through the first interface (IN11, IN12).

In summary, the invention discloses improved illumination of a light box (10), which is characterized in that it can be flexibly and dynamically adapted to different situations.
10 light box
La1 lighting means 1
La2 lighting means 2
BG1 operating device 1
BG2 operating device 2
IN11 (first) interface of the operating device BG1
IN12 (second) interface of the operating device BG2
SE1 sensor 1
SE2 sensor 2
SG control device
BG bus coupler
MS superordinate control system
RW back side
SW side wall
FS front side

1. Method for illuminating a light box (10) for illuminated advertising, having at least two lighting devices, wherein
at least two lighting devices (La1, La2), each being operated by an operating device (BG1, BG2),
the operating devices (BG1, B2) are connected to each other through an interface (IN11, IN12),
a control device (SG) which is connected with both operating devices (BG1, BG2) through the interface (IN11, IN12),
at least two different sensors (SE1, SE2) connected with the control device (SG),
wherein the control device (SG) transmits control signals through the first interface (IN11, IN12), which depend on the sensor signals detected by the sensors and which control the lighting devices (La1, La2) depending on the control signals received through the first interface.

2. Light box (10), for illuminated advertising, having at least one transparent front side (FS) which is illuminated by at least two lighting devices, comprising:
at least two lighting devices (La1, La2),
at least two operating devices (BG1, BG2), each operating one lighting devices (La1, La2), wherein each of the operating devices (BG1, BG2) is equipped with a first interface (IN11, IN12) and the first interfaces (IN11, IN12) are connected with each other and with a control device (SG), wherein two different sensors (SE1, SE2) are connected with the control device (SG) and the lighting devices (La1, La2) are controlled by the operating devices (BG1, BG2) depending on the control signals received through the first interface (IN11, IN12).

3. The light box (10) according to claim 2, wherein the different sensors (SE1, SE2) are brightness sensors.

4. The light box (10) according to claim 2, wherein unidirectional or bidirectional communication is enabled through the first interface (IN11, IN12) between the control device (SG) and the operating devices (BG1, BG2).

5. The light box (10) according to claim 2, wherein the monitoring of a brightness within the light box (10) is performed by the first sensor (SE1) and the monitoring of a brightness outside the light box is performed by the second sensor (SE2).

6. The light box (10) according to claim 2, further comprising additional operating devices (BG3, BG4) having at least a first interface (IN13, IN14).

7. The light box (10) according to claim 2, wherein one bus coupler (BK) is provided, which is connected with the first interface (IN11, IN12) and which enables coupling of an interface to a superordinate control system (MS).

8. The light box (10) according to claim 2, wherein the control device (SG) enables an interface coupling to a superordinate control system (MS).

9. The light box (10) according to claim 8, wherein different control signals can be transmitted through the first interfaces (IN11, IN12), wherein only some of the transmitted signals are further transmitted by the bus coupler (BK) or the control device (SG) to the superordinate control system (MS).

10. The light box (10) according to claim 2, wherein the lighting devices are organic or inorganic LEDs or gas discharge lamps.

11. The light box (10) according to claim 2, wherein the light box (10) is equipped with a reflective back side (RW) or with a transparent back side (RW).

12. The light box (10) according to claim 2, wherein the light box (10) is equipped with a reflective side wall (SW) or with a transparent side wall (SW).

13. The light box (10) according claim 2, wherein a motion detector is additionally connected to the control device (SG).

14. The light box according to claim 2, wherein the control device (SG) performs an evaluation of the time of day based on the progress of ambient brightness and adjusts the control of the control devices (BG1, BG2) to a detected time of day.

15. A method for illuminating a light box (10), for illuminated advertising, having at least one lighting device (La1), the method comprising:
arranging at least one sensor (SE1) in the light box (10),
detecting, via the sensor (SE1), a sum of artificial light and ambient light,
deactivating the artificial light and performing a measurement, via the sensor (SE1), during the deactivated period,
adjusting the lighting with respect to brightness.

16. The method according to claim 15, wherein a determination of a difference between brightness levels can be made based on the proportion of artificial light and of ambient light.

17. The method according to claim 15, wherein the deactivation period is timed such that a change in brightness is not perceptible by human eye.

18. Light box (10), for illuminated advertising, comprising at least a transparent front side (FS), which is illuminated by at least one lighting device (La1), and at least one sensor (SE1), wherein the sensor (SE1) detects a sum of artificial light and ambient light, the artificial light is deactivated and a measurement is performed by the sensor (SE1) during deactivation, the illumination is correspondingly adjusted with respect to brightness.
